(19) United States
(12) Patent Application Publication
(10) Pub. No.: US 2004/0109987 A1
(43) Pub. Date: Jun. 10, 2004

(54) Plate having light and shade thereon, three- dimensional model, and order system therefor

(76) Inventors: Takafumi Nakayama, Osaka (JP); Hitoshi Kihara, Osaka (JP); Nobuyuki Kondou, Osaka (JP); Tatsuyuki Nakagawa, Osaka (JP); Naoya Ishikawa, Osaka (JP); Yoshiaki Noguchi, Osaka (JP)

Correspondence Address: RABIN & Berdo, PC, 1101 14TH STREET, NW, SUITE 500, WASHINGTON, DC, 20005, US

(21) Appl. No.: 10/472,862

(22) PCT Filed: Mar. 26, 2002
(86) PCT No.: PCT/JP02/02880

(30) Foreign Application Priority Data
Mar. 28, 2001 (JP) 2001-93387
Mar. 28, 2001 (JP) 2001-93388

(51) Int. Cl. B32B 3/00

(52) U.S. Cl. 428/172; 428/156

(57) ABSTRACT

A plate having light and shade thereon, wherein a semi-transparent film (3) is formed on an opaque or light reflective bedding plate (2) having a variable thickness according to the shading of an image by flushing and solidifying semi-transparent liquid, the thick portion of the semi-transparent film (3) reflects less quantity of light since much reflected light from the bedding plate (2) is absorbed by the semi-transparent film (3), and the thin portion of the semi-transparent film (3) reflects much quantity of light since the reflected light from the bedding plate (2) is not much absorbed by the semi-transparent film (3), whereby the bright and dark or light and shadow of the expressed image can be expressed by utilizing the reflected light (FIG. 1).

### TECHNICAL FIELD

The present invention relates to a plate or three-dimensional model featuring shades representation and an order system therefor.

### BACKGROUND ART

In a case where an imagewise representation on a surface of a plate-like object is desired, it may be contemplated to affix thereto a copy of an image or a photograph. However, this approach encounters a problem of low durability associated with peeling of the copy or photograph, or the like.

In a case where the shades representation on a surface of a three-dimensional model is desired, it may be contemplated to paint the surface thereof. However, this approach is not adapted for mass production.

On the other hand, there is known a shading method assuring the product durability and adapted for mass production, the method wherein a translucent resin plate is formed in a manner that the thickness thereof is varied according to the image shades. When light is irradiated on a back side of the plate, the transmitted light therethrough faithfully reproduces the image shades and hence, the image is allowed to appear on the plate.

FIG. 9 shows a cross-sectional profile of a translucent resin plate 40 having such thickness variations.

Since the aforesaid translucent resin plate 40 is designed to be viewed via the light transmitted therethrough, the plate always need be held to light in order to observe the image thereon. The shades representation on the translucent three-dimensional model dictates the need for disposing a light source within the three-dimensional model such that the imagewise representation may be viewed via the transmitted light.

In this connection, a demand exists for the realization of an image representation method which utilizes the reflection of an external light for permitting the image shades to be observed.

It is therefore an object of the invention to provide a plate or three-dimensional model accomplishing a high durability and featuring imagewise representation with shades observable via reflective light.

### DISCLOSURE OF THE INVENTION

(1) A plate featuring imagewise representation according to the invention is characterized in that a translucent film varied in thickness according to the shades of an image to be represented is overlaid on an opaque or light reflective base plate.

According to the above arrangement, reflective light through a thicker portion of the translucent film is absorbed by the film in a greater quantity so as to be significantly reduced in quantity. On the other hand, a reflective light through a thinner portion of the translucent film is not much absorbed by the film and hence, the reflective light therethrough is relatively greater in quantity. Thus, the luminance variations or shades of the image to be represented can be reproduced. Since the translucent film absorbs a part of the light therethrough, the film may also be called “a semi-absorptive film”.

The “opaque or light reflective base plate” as a substrate may be formed from any material that can reflect light toward the translucent film.

The translucent film may comprise a resin incorporating therein a pigment. However, a material for the translucent film is not limited to this and may include other materials such as rubber and glass.

In the plate featuring imagewise representation, the translucent film over the base plate varied in thickness according to the shades of the image may be formed by pouring a translucent fluid over the base plate followed by solidifying the fluid.

In the plate featuring imagewise representation, the translucent film over the base plate may be formed by solidification in a mold having its thickness varied in correspondence to the shades of the image or otherwise, the translucent film over the base plate may be shaped by cutting the film to thicknesses corresponding to the shades of the image.

(2) In accordance with the invention, a three-dimensional model featuring shades representation is characterized in that a translucent film varied in thickness according to the shades of an image to be represented is overlaid on an opaque or light reflective three-dimensional base model.

According to the above arrangement, reflective light through a thicker portion of the translucent film is absorbed by the film in greater quantity so as to be significantly decreased in the light quantity thereof. On the other hand, the reflective light through a thinner portion of the translucent film is not much absorbed by the film and hence, the reflective light therethrough is relatively greater in the light quantity. Thus, the shades or luminance variations of the image to be represented can be reproduced.

The “opaque or light reflective three-dimensional base model” may be formed from any material that can reflect light toward the translucent film.

The above translucent film may comprise a resin incorporating therein a pigment. However, a material for the translucent film is not limited to this and may include other materials such as rubber and glass.

In the three-dimensional model featuring shades representation, the translucent film over the three-dimensional base model varied in thickness according to the shades of the image may be formed by applying a translucent fluid to the base model followed by solidifying the fluid to a smooth surface.

In the three-dimensional model featuring shades representation, the translucent film over the three-dimensional base model may be formed by solidification in a mold having its thickness varied in correspondence to the shades of the image or otherwise, the translucent film over the three-dimensional base model may be shaped by cutting the film to thicknesses corresponding to the shades of the image.

(3) In accordance with the invention, an order system for a plate having an arrangement wherein a translucent film varied in thickness according to the shades of an image to be represented is overlaid on an opaque or light reflective base plate,

the system wherein an order acceptance computer installed at store, an order handling computer installed at a management section on a business-operator side, and a production management computer installed at a production section on the business-operator side are interconnected via a communication line, and

wherein the store is provided with an image input apparatus while the following operations (a) to (d) are permitted:

(a) A customer operates the order acceptance computer to enter an image via the image input apparatus;

(b) The order handling computer stores the contents of the input order and sends the contents thereof to the production management computer;

(c) The production management computer gives directions for production based on the contents of the order and manages a production process; and

(d) The order handling computer receives a report on the production process from the production management computer so as to manage the progress of the production.

This order system provides for quick and positive information transmission between the customer, the management section and the production section, thus achieving increased operation efficiencies.

Particularly where provisions are made such that the customer can confirm the information on the made order or check on the progress of the production via the order acceptance computer at store or any other arbitrary computer, the customer can readily and quickly receive necessary information.

Furthermore, where provisions are made such that the customer can amend the information on the made order or add an additional item thereto via the order acceptance computer at store or any other arbitrary computer, the customer can give a proper direction to amend the order as viewing the computer screen.

In accordance with the invention, an order system for a three-dimensional model having an arrangement wherein a translucent film varied in thickness according to the shades of an image to be represented is overlaid on an opaque or light-reflective three-dimensional base model,

the system wherein an order acceptance computer installed at store, an order handling computer installed at a management section on a business-operator side, and a production management computer installed at a production section on the business-operator side are interconnected via a communication line, and

wherein the store is provided with an image input apparatus while the following operations (e) to (h) are permitted:

(e) A customer operates the order acceptance computer to enter image information via the image input apparatus;

(f) The order handling computer stores the contents of the input order and sends the contents thereof to the production management computer;

(g) The production management computer gives directions for production based on the contents of the order and manages a production process; and

(h) The order handling computer receives a report on the production process from the production management computer so as to manage the progress of the production.

This order system provides for quick and positive information transmission between the customer, the management section and the production section, thus achieving increased operation efficiencies.

Particularly where arrangement is made such that the customer can confirm the information on the made order or check on the progress of the production via the order acceptance computer at store or any other arbitrary computer, the customer can readily and quickly receive necessary information.

Furthermore, where provisions are made such that the customer can amend the information on the made order or add an additional item thereto via the order acceptance computer at store or any other arbitrary computer, the customer can give a proper direction to amend the order as viewing the computer screen.

The best mode for carrying out the invention will hereinbelow be described in details with reference to the accompanying drawings.

### BRIEF DESCRIPTION OF THE DRAWINGS

FIG. 1 is a sectional view showing an image plate 1 wherein a base plate 2 is varied in the thickness thereof according to the shades of an image;

FIG. 2 is a sectional view showing an image plate 4 wherein a translucent film 3 formed with projections and depressions according to the shades of an image is overlaid on a flat base plate 5;

FIG. 3 is a sectional view showing a three-dimensional model 11 wherein a base is varied in the thickness thereof according to the shades of an image;

FIG. 4 is a flow chart representing the steps of production of the three-dimensional model;

FIG. 5 is a sectional view showing a three-dimensional model 14 wherein a translucent film 13 formed with projections and depressions according to the shades of an image is overlaid on a base model 15 free from unevenness information;

FIG. 6 is a block diagram illustrating a concept of an order system for an image plate or three-dimensional model;

FIG. 7 is a diagram explaining how the contents of an ordered image plate are amended via a computer 37 installed at home;

FIG. 8 is a diagram explaining how the contents of an ordered three-dimensional model are amended via the computer 37 installed at home;

FIG. 9 is a sectional view showing a conventional translucent plate 40 formed with projections and depressions;

FIG. 10 is a perspective view showing a cylinder body 50 used for acquiring geometrical information on the three-dimensional model 11; and

FIG. 11 is a perspective view showing how an object image 38 in a projection image is projected onto the cylinder body 50 by a camera.

### BEST MODE FOR CARRYING OUT THE INVENTION

1. Production of Image Plate

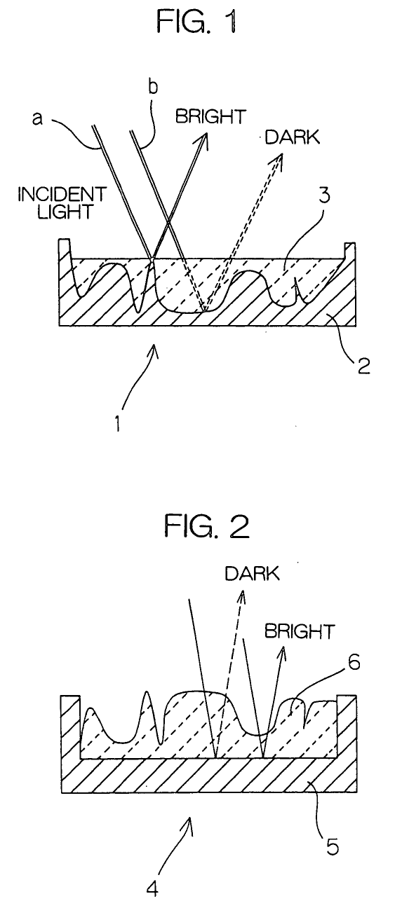

FIG. 1 is a sectional view showing a plate 1 with an image representation (hereinafter referred to as “image plate”) which is produced according to the invention.

The image plate 1 includes an opaque base plate 2 and a translucent film 3.

A surface contour of the base plate 2 is formed by varying the thickness thereof according to the shades of an image. A method for forming the base plate 2 is not limited. For instance, the base plate may be formed by compacting a material in a mold formed with projections and depressions in correspondence to the image shades, or by cutting a soft resin material according to the shades of the image. The material for the base plate 2 is not particularly limited and may include metals, resins, rubbers, wood materials, gypsum and the like. The base plate 2 may preferably have an opposite dark/light relation with the translucent film 3 such that a surface of the base plate may reflect as much light as possible. Where the base plate 2 is formed from a dark colored material or is colored dark at the uneven surface thereof, for example, the translucent film 3 may preferably have a whitish color. Conversely where the base plate 2 is formed from a white material or is colored white at the uneven surface thereof, the translucent film 3 may preferably have a dark color.

The base plate 2 has a greater thickness at a portion corresponding to a bright area of the image, while having a smaller thickness at a portion corresponding to a dark area of the image.

The translucent film 3 is formed by pouring a gel-like translucent fluid over the uneven surface of the base plate 2 and solidifying the fluid. Therefore, the resultant translucent film 3 has a smaller thickness at place corresponding to the thicker portion of the base plate 2 and a greater thickness at place corresponding to the thinner portion of the base plate.

A material for the translucent film 3 may be optically characterized by absorbing light at an absorptivity in a predetermined range and allowing the penetration of un-absorbed light. A usable material may be prepared by, for example, admixing a coloring pigment (Product No: R-17 Black) in a transparent epoxy resin in a volume ratio of about 0.2% and kneading the resultant mixture. The pigment is not limited to black. Where a red image plate is desired, for example, a red pigment maybe used. Where a white image plate is desired, a white pigment may be used.

According to the image plate 1 of the above configuration, an incident light ‘a’ upon the thicker portion of the base plate 2 as penetrating the thinner portion of the translucent film 3 is reflected by the base plate 2 as penetrating the translucent film 3. An incident light ‘b’ upon the thinner portion of the base plate 2 as penetrating the thicker portion of the translucent film 3 is reflected by the base plate 2 as penetrating the translucent film 3. The incident light ‘a’ has a shorter light path through the translucent film 3 so as to be absorbed less than the incident light ‘b’ and hence, is emitted as light of a higher intensity. On the other hand, the incident light ‘b’ has a longer light path through the translucent film 3 so as to be absorbed more and hence, is emitted as light of a lower intensity. Accordingly, light rays having intensities corresponding to the image shades enter the eyes or a camera lens so that an original image is reproduced.

Although the image plate is produced by pouring the translucent fluid over the uneven surface of the base plate 2 according to the foregoing embodiment, the image plate maybe produced by solidifying the translucent fluid in a mold.

FIG. 2 is a sectional view showing an image plate 4 which is produced by the steps of spreading a molten translucent resin over a flat base plate 5; and solidifying the translucent resin with a mold (not shown) pressed thereagainst, the mold formed with projections and depressions corresponding to the shades of the image. According to this example, the image shades information consists in the projections and depressions of the mold. In this image plate 4, as well, the luminance variations corresponding to the thickness variations of a translucent film 6 can be perceived.

In an alternative method to that illustrated by the image plate 4 of FIG. 2, the unevenness can be produced by the steps of overlaying a translucent resin on the flat base plate, and cutting the translucent resin into an uneven surface contour.

2. Production of Three-Dimensional Model

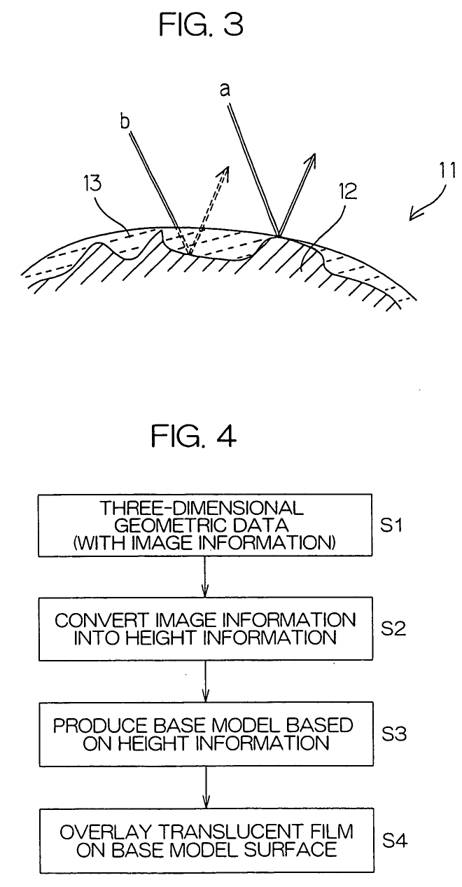

FIG. 3 is a sectional view showing a three-dimensional model 11 with image representation according to the invention (hereinafter, referred to as “three-dimensional model”).

The three-dimensional model 11 includes an opaque three-dimensional base model (hereinafter, referred to as, “base model”) 12, and a translucent film 13.

A surface of the base model 12 is varied in the height thereof according to the shades of the image. There is no limitation to a method for producing the base model 12, which may be produced by, for example, (1) compacting a resin material in molds formed with projections and depression corresponding to the shades of the image; or (2) cutting a soft resin mass to heights represented by the image shades. A material for the base model 12 is not particularly limited and may include metals, resins, rubbers, wood materials, gypsum and the like.

The base model 12 may preferably have an opposite dark/light relation with the translucent film 13 such that a surface of the base model may reflect as much light as possible. Where the base model 12 is formed from a dark colored material or is colored dark at the surface thereof, for example, the translucent film 13 may preferably have a whitish color. Conversely where the base model 12 is formed from a white material or is colored white at the surface thereof, the translucent film 13 may preferably have a dark color.

The base model 12 is protruded at a portion corresponding to a brighter area of the image (say, a skin area of a face image) but is depressed at a portion corresponding to a darker area of the image (say, the hair and irises of the face image).

The translucent film 13 is formed by applying a gel-like translucent fluid to the uneven surface of the base model 12, and solidifying the fluid to a smooth surface or smooth grinding the solidified mass. Accordingly, the translucent film 13 is formed in a smaller thickness at place corresponding to the protruded portion of the base model 12 and in a greater thickness at place corresponding to the depressed portion thereof.

A material for the translucent film 13 may be optically characterized by absorbing light at an absorptivity in a predetermined range. A usable material may be prepared by, for example, admixing a coloring pigment (Product No: R-17 Black) in a transparent epoxy resin in a volume ratio of about 0.2% and kneading the resultant mixture. The pigment is not limited to black. Where a red three-dimensional model is desired, for example, a red pigment may be used. Where a white three-dimensional model is desired, a white pigment may be used.

FIG. 4 is a flow chart explanatory of the aforementioned production procedure. The flow chart represents a flow of processings done by a production management computer to be described hereinlater.

When three-dimensional geometric data including image information (used herein to mean the same as shades information or luminance variations information) are inputted to the production management computer (Step S1), the production management computer converts the image information into height information (Step S2). A base model is produced based on the height information (Step S3). Where the three-dimensional geometric data represents a man's head, for example, a head model is produced based on the data and then is subjected to cutting for forming protrusions or depressions on the surface of the model.

Subsequently, a translucent film is applied to the surface of the base model, allowed to solidify and then finished to a smooth surface. Thus is obtained the three-dimensional model (Step S4).

According to the three-dimensional model of the above configuration as shown in FIG. 3, an incident light ‘a’ upon the protruded portion of the base model 12 as penetrating the thinner portion of the translucent film 13 is reflected by the base plate 2 as penetrating the translucent film 13. An incident light ‘b’ upon the depressed portion of the base model 12 as penetrating the thicker portion of the translucent film 13 is reflected by the base model 12 as penetrating the translucent film 13. The incident light ‘a’ has a shorter light path through the translucent film 13 than the incident light ‘b’ so as to be absorbed less than the incident light ‘b’ and hence, is emitted as light of a higher intensity. On the other hand, the incident light ‘b’ has a longer light path through the translucent film 13 so as to be absorbed more and hence, is emitted as light of a lower intensity. Accordingly, light rays having intensities corresponding to the shades of the image enter the eyes or a camera lens so that an original image is reproduced on the base model 12.

Although the three-dimensional model is produced by applying the translucent fluid onto the uneven surface of the base model 12 according to the foregoing embodiment, the three-dimensional model may be produced by solidifying the translucent fluid in a mold.

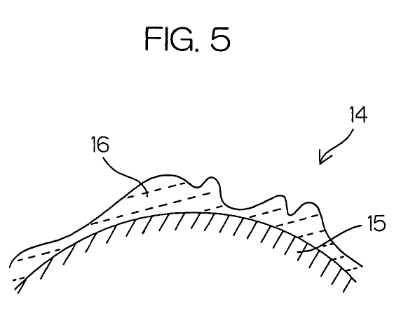

FIG. 5 is a sectional view showing a three-dimensional model 14 produced by the steps of: applying a molten translucent resin onto a base model 15 free from unevenness information, and solidifying the translucent resin with molds (not shown) pressed thereagainst, the molds formed with projections and depressions corresponding to the shades of the image. According to this example, the image shades information consists in the projections and depressions of the molds. In this three-dimensional model 14, as well, the luminance variations corresponding to the thickness variations of the translucent film 16 can be perceived.

In an alternative method to that illustrated by the three-dimensional model 14 of FIG. 5, the unevenness can be produced by the steps of applying a translucent resin onto the base model without the unevenness information, and cutting the translucent resin into an uneven surface contour.

3. Order System

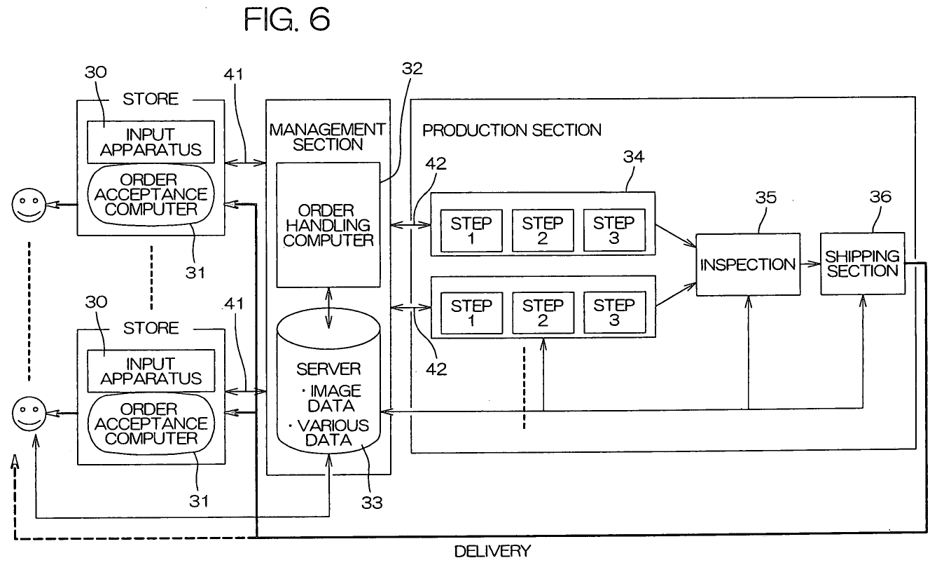

FIG. 6 is a block diagram illustrating a concept of an order system for an image plate or a three-dimensional model. In FIG. 6, thin lines with arrows represent data communications lines, whereas thick lines with arrows represent delivery routes.

A business operator owns a plurality of stores, a management section (office) and a production section (plant).

The store is provided with an order acceptance computer 31 including an image input apparatus 30. The management section is provided with a computer 32 for handling the accepted order and a server 33 for storing various data. The production section is provided with a computer 34 for managing production processes for producing the image plate or three-dimensional model, an inspection apparatus 35 for inspecting a resultant product, and a shipping station 36 for shipping a conforming product.

The image input apparatus 30 is equipped with a plurality of cameras and a computer (not shown), thus adapted to acquire geometrical information and shades information on an original three-dimensional object.

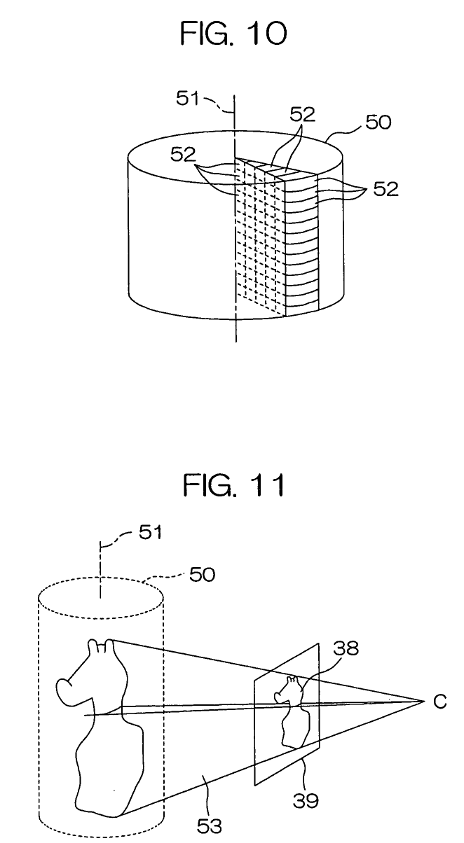

Now referring to FIGS. 10 and 11, description is made on a specific method for acquiring the geometrical information and shades information on the three-dimensional object. A three-dimensional model is placed in a cylinder body 50 having an axis 51 and the cylinder body is divided into unit spaces (voxels) 52 representing cylindrical co-ordinates. Then, a pyramid-shaped space (referred to as “a virtual presence space”) 53 is defined which has a sectional shape defined by an object image 38 in a projection image 39 and a vertex positioned at a projection center C of the camera. “1” is voted for a voxel of the virtual presence space in the cylinder body 50 (voting process). Such a voting process is performed on each image projected from each of the installed cameras. The number of votes for each voxel is added up. A threshold is set such that a portion having a greater number of votes than the threshold is determined to constitute the three-dimensional geometry of the three-dimensional model (Japanese Unexamined Patent Publication No. 10-124704). The shades information may be acquired by applying luminance values of the object image 38 picked up by the camera to the surface contour of the three-dimensional model.

The order acceptance computer 31 is in connection with the order handling computer 32 and the server 33 at the management section via a data communication line 41. On the other hand, the order handling computer 32 and the server 33 are in connection with the production management computer 34 and a computer of the inspection apparatus 35 at the production section via a data communication line 42.

The product from the shipping section 36 is directly delivered to the store or a customer via a distributor.

In the above system, the customer may open a web page of the server 33 to operate the order acceptance computer 31 thereby inputting an image (such as a portrait of the customer) via the image input apparatus 30 and to define specifications (including, for example, a color, a material and the like) of a desired image plate or three-dimensional model

The order handling computer 32 stores the contents of the inputted order in the server 33 and sends the same to the production management computer 34.

Based on the contents of the order, the production management computer 34 gives directions for production and manages the production processes. In addition, the computer generates an imaginary image of a finished product.

Receiving a report on the production process of the product of interest from the production management computer 34, the order handling computer 32 controls the progress of the production. As required, the order handling computer 32 also retrieves the imaginary image of the finished product from the production management computer 34.

The customer is allowed to confirm information on the made order and to check on the progress of the production of the ordered product via the order acceptance computer 31 at store.

In addition, the customer is also allowed to amend the contents of the made order or add an additional item thereto via the order acceptance computer 31 at store or a computer 37 at home.

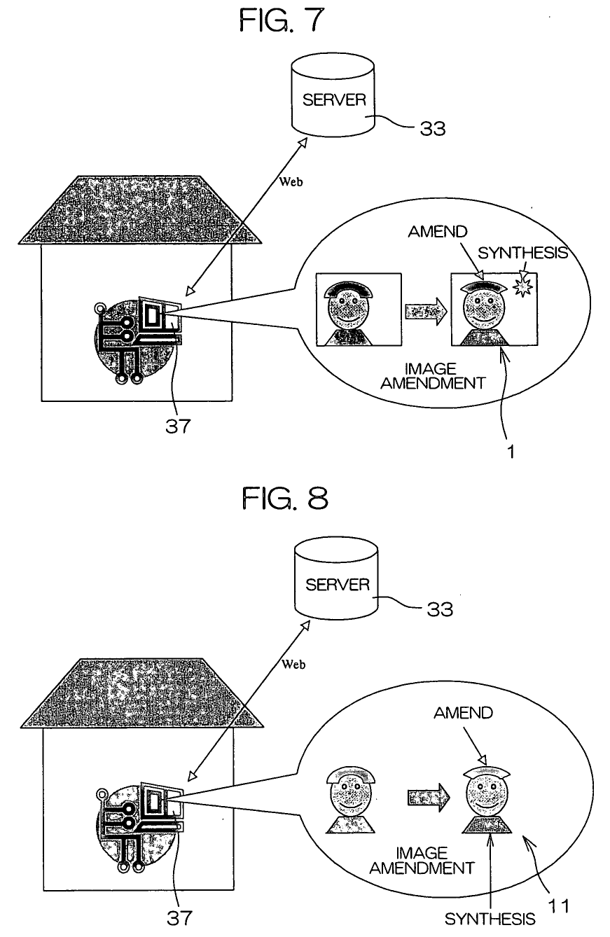

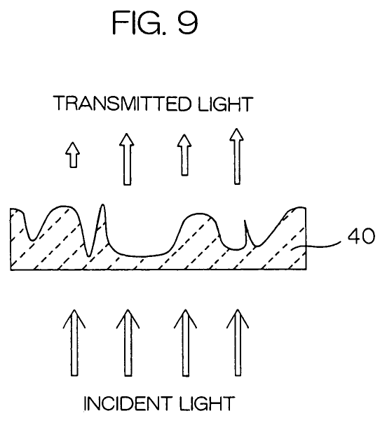

FIG. 7 is a diagram showing how the customer amends the contents of an ordered image plate or adds an additional item thereto via the computer 37 at home. A screen of the computer 37 displays an imaginary image of a finished product, via which the customer amends the image or adds a background.

FIG. 8 is a diagram showing how the customer amends the contents of an ordered three-dimensional model or adds an additional item thereto via the computer 37 at home. The screen of the computer 37 displays an imaginary image of a finished product, via which the customer amends the three-dimensional model or adds a tie thereto.

The amended contents and added item are sent to the order handling computer 32 which, in turn, accordingly changes the contents of the accepted order before storing the amended contents in the server 33. Subsequently, the amended contents of the order are sent to the production management computer 34 for altering the production processes.

1. A plate featuring imagewise representation, wherein a translucent film varied in thickness according to the shades of an image to be represented is overlaid on an opaque or light reflective base plate.

2. A plate featuring imagewise representation according to claim 1, wherein the translucent film comprises a resin incorporating therein a pigment.

3. A plate featuring imagewise representation according to claim 1, wherein the translucent film over the base plate varied in thickness according to the shades of the image is formed by pouring a translucent fluid over the base plate followed by solidifying the fluid.

4. A plate featuring imagewise representation according to claim 1, wherein the translucent film over the base plate is formed by solidification in a mold having its thickness varied in correspondence to the shades of the image.

5. A plate featuring imagewise representation according to claim 1, wherein the translucent film over the base plate is shaped by cutting the film to thicknesses corresponding to the shades of the image.

6. A three-dimensional model featuring shades representation wherein a translucent film varied in thickness according to the shades of an image to be represented is overlaid on an opaque or light reflective three-dimensional base model.

7. A three-dimensional model featuring shades representation according to claim 6, wherein the translucent film comprises a resin incorporating therein a pigment.

8. A three-dimensional model featuring shades representation according to claim 6, wherein the translucent film over the three-dimensional base model varied in thickness according to the shades of the image is formed by applying a translucent fluid to the base model followed by solidifying the fluid to a smooth surface.

9. A three-dimensional model featuring shades representation according to claim 6, wherein the translucent film over the three-dimensional base model is formed by solidification in a mold with its thickness varied in correspondence to the shades of the image.

10. A three-dimensional model featuring shades representation according to claim 6, wherein the translucent film over the three-dimensional base model is shaped by cutting the film to thicknesses corresponding to the shades of the image.

11. An order system for a plate having an arrangement wherein a translucent film varied in thickness according to the shades of an image to be represented is overlaid on an opaque or light reflective base plate,
the system wherein an order acceptance computer installed at store, an order handling computer installed at a management section on a business-operator side, and a production management computer installed at a production section on the business-operator side are interconnected via a communication line, and
wherein the store is provided with an image input apparatus while the following operations (a) to (d) are permitted:
(a) A customer operates the order acceptance computer to enter an image via the image input apparatus;
(b) The order handling computer stores the contents of the input order and sends the contents thereof to the production management computer;
(c) The production management computer gives directions for production based on the contents of the order and manages a production process; and
(d) The order handling computer receives a report on the production process from the production management computer so as to manage the progress of the production.

12. An order system according to claim 11, wherein the customer can confirm the information on the made order or check on the progress of the production via the order acceptance computer at store or any other arbitrary computer.

13. An order system according to claim 12, wherein the customer can amend the information on the made order or add an additional item thereto via the order acceptance computer at store or any other arbitrary computer.

14. An order system for a three-dimensional model having an arrangement wherein a translucent film varied in thickness according to the shades of an image to be represented is overlaid on an opaque or light-reflective three-dimensional base model,
the system wherein an order acceptance computer installed at store, an order handling computer installed at a management section on a business-operator side, and a production management computer installed at a production section on the business-operator side are interconnected via a communication line, and
wherein the store is provided with an image input apparatus while the following operations (e) to (h) are permitted:
(e) A customer operates the order acceptance computer to enter image information via the image input apparatus;
(f) The order handling computer stores the contents of the input order and sends the contents thereof to the production management computer;
(g) The production management computer gives directions for production based on the contents of the order and manages a production process; and
(h) The order handling computer receives a report on the production process from the production management computer so as to manage the progress of the production.

15. An order system according to claim 14, wherein the customer can confirm the information on the made order or check on the progress of the production via the order acceptance computer at store or any other arbitrary computer.

16. An order system according to claim 15, wherein the customer can amend the information on the made order or add an additional item thereto via the order acceptance computer at store or any other arbitrary computer.
